(19) United States
(12) Patent Application Publication
(10) Pub. No.: US 2025/0024147 A1
(43) Pub. Date: Jan. 16, 2025

(54) SYSTEM AND METHOD FOR STABILIZING ONE OR MORE SENSORS ON A VEHICLE

(71) Applicant: Continental Automotive Technologies GmbH, Hannover (DE)

(72) Inventor: Milos Djuric, Zurich (CH)

(73) Assignee: Continental Automotive Technologies GmbH, Hannover (DE)

(21) Appl. No.: 18/703,873

(22) PCT Filed: Sep. 29, 2022
(86) PCT No.: PCT/EP2022/077106

§ 371 Date: Apr. 23, 2024

(30) Foreign Application Priority Data
Oct. 25, 2021 (DE) 10 2021 211 978.6

(51) Int. Cl. H04N 23/68; G01S 7/02; G01S 13/931

(52) U.S. Cl. CPC H04N 23/685; G01S 7/027; G01S 13/931; H04N 23/6812; G01S 2013/9323

(57) ABSTRACT

A system for stabilizing one or more sensors on a vehicle having a vehicle frame is provided. This system comprises a sensor frame arranged for receiving one or more sensors and a sensor frame actuator, which attached to the sensor frame and to the vehicle. The system further comprises a first and a second inertial measurement unit. The first inertial measurement unit is attached to the sensor frame for determining a movement of the sensor frame. The second inertial measurement unit is attached to the vehicle frame for determining a movement of the vehicle frame. The sensor frame actuator is arranged for stabilizing the sensor frame with respect to the vehicle frame based on the determined movements.

### CROSS REFERENCE TO RELATED APPLICATIONS

This US patent application claims the benefit of PCT patent application No. PCT/EP2022/077106, filed Sep. 29, 2022, which claims the benefit of German patent application No. 10 2021 211 978.6, filed Oct. 25, 2021, both of which are hereby incorporated by reference.

### BACKGROUND

Many vehicles, especially trucks, have cabins that can move with respect to the truck frame in order to improve the comfort for the driver. This is achieved by creating a system which is often comprised of a gyroscope, a controller, an electromagnetic valve, an adjuster and an air storage tank. This system is mounted on the truck frame beneath the cabin and has the following working principle: the controller acquires the posture signal from the gyroscope and sends the control signal to the electromagnetic valve which controls the air inlet and outlet controlling the adjuster with those air pressure changes.

Many vehicles are provided with sensors (such as cameras, radar-devices and lidar-devices), in order to obtain information about the surroundings of the vehicles. Because their limited field of view, these sensors may be mounted on the forementioned cabins of these vehicles.

However, during turning, accelerating, and especially breaking of the vehicle, the movement of these cabins may become relatively large. Furthermore, during driving these cabins may vibrate somewhat. Both phenomena may not impact the driving comfort but may impact the functioning of the sensors.

The objective of the disclosure is to improve the functioning of sensors mounted on vehicles with moveable vehicle cabins.

### SUMMARY

The objective of the disclosure is met by providing a system according to the claims and a method according to claim 7.

According to a first aspect, a system for stabilizing one or more sensors on a vehicle having a vehicle frame is provided, the system comprising a sensor frame arranged for receiving said one or more sensors; a first inertial measurement unit attached to said sensor frame for determining a movement of said sensor frame; a second inertial measurement unit arranged to be attached to said vehicle frame and for determining a movement of said vehicle frame; and a sensor frame actuator, attached to said sensor frame and arranged for being attached to said vehicle, and arranged for stabilizing said sensor frame with respect to said vehicle frame based on said determined movements.

Determination of both the movement of the sensor frame and the vehicle frame enables the sensor frame actuator to keep the orientation of the sensor frame (and thus of the one or more sensors) with respect to the vehicle frame as much constant as possible. For example, when the vehicle is in stand-still and while it is breaking or making any other maneuver. In one of more embodiments, it may be formulated as the sensor frame being stabilized in a vehicle frame referential system.

In contrast, it would also be possible to stabilize the sensor frame in a gravitational referential system. However, if the sensor frame orientation should be parallel to the road the vehicle is driving on, this would not work when the vehicle is on slope.

A further advantage of the system may be that it is easily mounted on existing vehicles in an after-market situation.

A further advantage of the system may be that the sensor frame may be relatively small and/or light (for example in comparison with a complete cabin). Since the frame actuator is arranged for stabilizing this small and/or light object, it may be more reliable than an actuator arranged for stabilizing a large and/or heavy object.

In general, the term “movement” may refer to a translation and a rotation, but may also refer to just a rotation. Both translation and rotation may be in one, two or three dimensions.

In general, the term “sensor frame” may refer to a frame, a casing or any container that at least partly contains one or more sensors.

In one or more embodiments, the system further comprises one or more sensors attached to said sensor frame, wherein the one or more sensors comprise a camera, a radar-device, and/or a lidar-device. Especially radar- and lidar-devices and far-field cameras have a small, elongated field of view (in comparison with a near-field camera) that would need to be kept in parallel with the road.

The sensor frame may be arranged to be moveable attached to the vehicle, more especially to a cabin of the vehicle. The sensor frame actuator may be arranged to be mounted between the sensor frame and the vehicle.

According to a second aspect, a vehicle having a vehicle frame is provided, the vehicle comprising a cabin, which may be moveably attached to said vehicle frame; a cabin actuator, attached to said cabin and to said vehicle frame, arranged for stabilizing said cabin with respect to a gravitational reference frame; and a system for stabilizing one or more sensors on a vehicle having a vehicle frame, the system comprising a sensor frame arranged for receiving the one or more sensors, a first inertial measurement unit attached to the sensor frame for determining a movement of the sensor frame, a second inertial measurement unit arranged to be attached to the vehicle frame and for determining a movement of the vehicle frame, and a sensor frame actuator, attached to the sensor frame and arranged for being attached to the vehicle, and arranged for stabilizing the sensor frame with respect to the vehicle frame based on the determined movements, or wherein the system further comprises one or more sensors attached to the sensor frame, wherein the one or more sensors comprise a camera, a radar-device, and/or a lidar-device; and wherein said sensor frame actuator is attached to said cabin.

The cabin may be moveable attached to the vehicle frame. The cabin actuator may be mounted between the cabin and the vehicle frame. In one or more embodiments, stabilizing said cabin with respect to a gravitational reference frame may be formulated as stabilizing said cabin with respect to a horizontal plane.

In these embodiments, the cabin actuator may be arranged for stabilizing the cabin in the gravitational reference frame, while at the same time the sensor frame actuator is arranged for stabilizing the sensor frame in the vehicle reference frame.

In one or more embodiments, a stabilizing time scale of said sensor frame actuator is shorter than a stabilizing time scale of said cabin actuator. It may be the case that certain vibrations are not relevant for the comfort of the driver of the vehicle but do impact the functioning of the sensors. Therefore, the cabin actuator may ignore movements or vibrations below a certain time scale, while the sensor frame actuator should not ignore and try to counteract them as much as possible.

In one or more embodiments, a stabilizing accuracy of said sensor frame actuator is higher than a stabilizing accuracy of said cabin actuator. It may be the case, that, when stabilizing the cabin, a certain amount of overshoot or undershoot is acceptable and not relevant for the comfort of the driver. However, for a sensor this amount of overshoot or undershoot may be relevant for its functioning. The sensor frame actuator should therefore be arranged for limiting the overshoot and undershoot to larger extend than the cabin actuator.

In one or more embodiments, said vehicle is one of the following: a truck, a bus, a car, and a motorbike.

According to a third aspect, a computer-implemented method for stabilizing one or more sensors on a vehicle having a vehicle frame is provided, the method comprising the steps of determining a movement of a sensor frame arranged for receiving the one or more sensors; determining a movement of the vehicle frame arranged; and, stabilizing the sensor frame with respect to the vehicle frame based on the determined movements.

According to a fourth aspect, a computer program comprising instructions which, when the program is executed by a computer, cause the computer to carry out the steps of any of the embodiments as described in this document. Furthermore, a computer-readable medium is provided having stored thereon said computer program.

The working, advantages and embodiments of the receiver, the system, and the vehicle as well as the working, advantages and embodiments of the computer program and computer-readable medium, correspond with the working, advantages and embodiments of the method as described in this document, mutatis mutandis.

### BRIEF DESCRIPTION OF THE DRAWINGS

For a more complete understanding of the present disclosure, reference in the following description is made to the accompanying drawings in which:

FIG. 1 shows a schematic overview of a system for stabilizing one or more sensors and a vehicle comprising such a system according to one or more embodiments of the disclosure; and,

FIG. 2 shows a schematic overview of a method stabilizing one or more sensors on a vehicle according to one or more embodiments of the disclosure.

### DETAILED DESCRIPTION

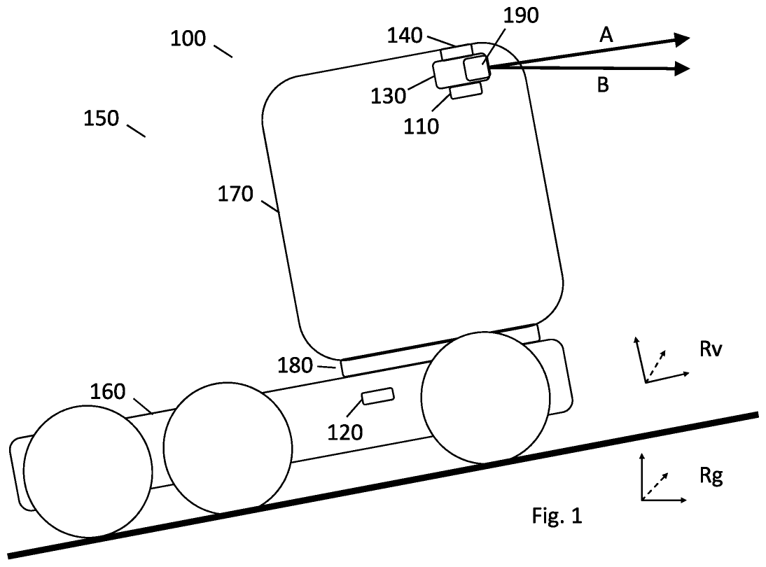

FIG. 1 shows a schematic overview of a system 100 for stabilizing one or more sensors 190, and a vehicle 150 comprising system 100. System 100 comprises a sensor frame 130, a first inertial measurement unit 110, a second inertial measurement unit 120 and a sensor frame actuator 140. In the example of FIG. 1, the vehicle 150 is a truck with a cabin 170 and a vehicle frame 160.

The sensor frame 130 is arranged for receiving one or more sensors 190. In the example of FIG. 1, the sensor 190 may be far-field camera, a radar device or a lidar device. The sensor may have an orientation or direction of the field of view. In FIG. 1, two possible directions are indicated by the letter A and B respectively. Since the sensor are mounted on or in the sensor frame 130, a change of orientation of the sensor frame 130 will result in a change of the orientation or direction of the one or more sensors.

The first inertial measurement unit 110 is attached to the sensor frame 130 and is arranged for determining a movement of the sensor frame 130. In general, inertial measurement units may comprise an accelerometer, a gyroscope sensor, and/or a magnetometer.

The sensor frame actuator 140 is attached to the sensor frame 130 and arranged for stabilizing the sensor frame 130 with respect to the vehicle frame 160. The sensor frame actuator may comprise of one or more actuators, for example 3 or 4, such that the sensor frame actuator is able to change the position and/or orientation of sensor frame 130. Such one or more actuators may be an electrical stepper motor.

The second inertial measurement unit 120 is, in the example of FIG. 1, attached to the vehicle frame 160 and arranged for detecting a movement of vehicle frame 160.

In the example of FIG. 1, the vehicle 150 has a cabin 170, which may be moveably attached to the vehicle frame 160. Between the cabin 170 and the vehicle frame 160 a cabin actuator 180 may be mounted, which is arranged for stabilizing said cabin with respect to the gravitational reference frame Rg (or with respect to a horizontal frame) in order to improve the driving comfort of users of the vehicle 150.

In order to optimize the functioning of sensor 190, it may be desirable to mount the sensor 190 on cabin 170. In the example of FIG. 1, the vehicle 150 is riding on a slope. When accelerating or de-accelerating, the cabin 170 may be moving with respect to the vehicle frame 160, due to the inertia of the cabin 170. The cabin actuator 180 may be arranged for stabilizing the cabin 170 with respect to the gravitational reference frame Rg.

In the example of FIG. 1, the main movements may all be in the direction of travel. However, it may be understood that the invention may also be advantageously applied when movements are in a direction perpendicular to the direction of travel. This is for example the case when one of the wheels of the vehicle is going over a bump in the road or through a hole in the road.

If the sensor frame 130 is fixedly mounted on or in the cabin 170, the orientation of the sensor 190 will also be stabilized with respect to the gravitational reference frame Rg. This may result in the sensor 190 having an orientation as indicated by letter B. However, this may impact the field of view of sensor 190 negatively, as may be seen in FIG. 1.

Therefore, according to the disclosure, the sensor frame actuator 140 is able to stabilizing the sensor frame 130 with respect to the vehicle frame 160 (i.e. in the vehicle reference frame Rv). This may result in the sensor 190 having an orientation as indicated by letter A, which may be the optimum orientation as it is also present when driving on a flat road.

In order to stabilize the sensor frame 130 with respect to the vehicle frame 160 the sensor frame actuator 140 may require information about the movement of both the vehicle frame 160 and the sensor frame 130 and thus data from both the first inertial measurement unit 110 and the second inertial measurement unit 120.

In one or more embodiments, in order to further improve the functioning of the sensor 190, the stabilizing time scale of the sensor frame actuator 140 may be shorter than a stabilizing time scale of the cabin actuator 180 and the stabilizing accuracy of the sensor frame actuator 140 may be higher than a stabilizing accuracy of the cabin actuator 180.

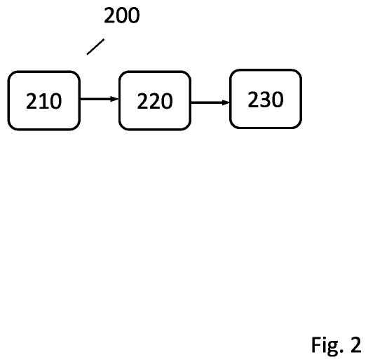

FIG. 2 shows a schematic overview of a method stabilizing one or more sensors on a vehicle according to one or more embodiments of the disclosure. The method comprises the following steps: Step 210: determining a movement of a sensor frame 130 arranged for receiving said one or more sensors 190; Step 220: determining a movement of said vehicle frame 160; and, Step 230: stabilizing said sensor frame 130 with respect to said vehicle frame 160 based on said determined movements.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The benefits and advantages that may be provided by the present disclosure have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present disclosure has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the disclosure as detailed within the following claims.

1. A system for stabilizing one or more sensors on a vehicle having a vehicle frame, the system comprising:
a sensor frame arranged for receiving the one or more sensors;
a first inertial measurement unit attached to the sensor frame for determining a movement of the sensor frame;
a second inertial measurement unit arranged to be attached to the vehicle frame and for determining a movement of the vehicle frame; and
a sensor frame actuator, attached to the sensor frame and arranged for being attached to the vehicle, and arranged for stabilizing the sensor frame with respect to the vehicle frame based on the determined movements.

2. A system according to claim 1, further comprising one or more sensors attached to the sensor frame, wherein the one or more sensors comprise a camera, a radar-device, and/or a lidar-device.

3. A vehicle having a vehicle frame, comprising:
a cabin;
a cabin actuator, attached to said cabin and to the vehicle frame, arranged for stabilizing the cabin with respect to a gravitational reference frame; and
a system comprising:
a sensor frame arranged for receiving the one or more sensors;
a first inertial measurement unit attached to the sensor frame for determining a movement of the sensor frame;
a second inertial measurement unit arranged to be attached to the vehicle frame and for determining a movement of the vehicle frame; and
a sensor frame actuator, attached to the sensor frame and arranged for being attached to the vehicle, and arranged for stabilizing the sensor frame with respect to the vehicle frame based on the determined movements,
wherein the sensor frame actuator is attached to the cabin.

4. A vehicle according to claim 3, wherein a stabilizing time scale of the sensor frame actuator is shorter than a stabilizing time scale of the cabin actuator.

5. A vehicle according to claim 3, wherein a stabilizing accuracy of the sensor frame actuator is higher than a stabilizing accuracy of the cabin actuator.

6. A vehicle according to claim 3, wherein the vehicle is a truck.

7. A computer-implemented method for stabilizing one or more sensors on a vehicle having a vehicle frame, the method comprising steps of:
determining a movement of a sensor frame arranged for receiving the one or more sensors;
determining a movement of the vehicle frame; and,
stabilizing the sensor frame with respect to the vehicle frame based on the determined movements.

8. (canceled)

9. (canceled)
